(19) United States
(12) Patent Application Publication
(10) Pub. No.: US 2008/0296870 A1
(43) Pub. Date: Dec. 4, 2008

(54) Trailer hitch assembly for a bomb disposal robot method therefor

(76) Inventors: Geoffrey C. Archer, Las Vegas, NV (US); Tim Ignatiuk, Las Vegas, NV (US)

Correspondence Address: WEISS & MOY PC, 4204 NORTH BROWN AVENUE, SCOTTSDALE, AZ, 85251, US

(21) Appl. No.: 11/809,711

(22) Filed: Jun. 4, 2007

(51) Int. Cl. B60D 1/14

(52) U.S. Cl. 280/504; 901/1

(57) ABSTRACT

A trailer hitch assembly for a bomb disposal robot has a support beam for removably attaching the trailer hitch assembly to the bomb disposal robot. A female trailer hitch connector is coupled to the support beam.

### BACKGROUND OF INVENTION

1. Field of Invention

The present invention relates to a trailer hitch and, more particularly, to a trailer hitch assembly for a bomb disposal robot to provide increased functionality for the bomb disposal robot.

2. Description of Related Art

Presently, many bomb disposal teams are outfitted with a bomb disposal robot. Bomb disposal robots are generally outfitted with cameras, microphones, and sensors for chemical, biological, or nuclear agents. The bomb disposal robot is used to approach suspected devices, and with the use of video technology, a bomb disposal team member can more safely render suspected devices safe. Many of these bomb disposal robots even have hand-like manipulators in case a door needs to be opened, or a munition or bomb requires handling or moving.

Once the bomb disposal team member determines what the munition or device is, and what state it is in, the team member will formulate a procedure to disarm it. This may include things as simple as replacing safety features, or as difficult as using high-powered explosive-actuated devices to shear, jam, bind, or remove parts of the item's firing train. Preferably, this will be accomplished remotely.

Presently, a bomb disposal robot is limited in functionality to the equipment directly outfitted on the bomb disposal robot. Additional functionality could be provided by attaching a trailer or other device to the bomb disposal robot. This would allow the bomb disposal robot to carry additional equipment, bomb disposal containers, and the like. However, presently, there are no trailer hitches outfitted for bomb disposal robots,

Therefore, it would be desirable to provide an apparatus and method that overcomes the above problem. The apparatus and method would allow a bomb disposal robot to pull a trailer or other device to increase functionality of the bomb disposal robot.

### SUMMARY OF INVENTION

In accordance with one embodiment of the present invention, a trailer hitch assembly for a bomb disposal robot is disclosed. The trailer hitch assembly has a support beam for removably attaching the trailer hitch assembly to the bomb disposal robot. The support beam has an “L” shaped member extending from a first end and a second end of the support beam. The horizontal leg of the “L” shaped member extends above and away from the support beam. The horizontal leg of the “L” shaped member is approximately parallel to the support beam. A support plate is removably coupled to a top of the support beam. A female trailer hitch connector is mounted to the support plate.

In accordance with another embodiment of the present invention, a trailer hitch assembly for a bomb disposal robot is disclosed. The trailer hitch assembly has a support beam for removably attaching the trailer hitch assembly to the bomb disposal robot. A female trailer hitch connector is permanently mounted to the support beam. A pair of support members is permanently attached to the support beam and the female trailer hitch connector.

The foregoing and other objects, features, and advantages of the invention will be apparent from the following, more particular, description of the preferred embodiments of the invention, as illustrated in the accompanying drawing.

### BRIEF DESCRIPTION OF DRAWINGS

The present invention will become more fully understood from the detailed description and the accompanying drawings, wherein:

FIG. 1 is a side view of a bomb disposal robot with the trailer hitch of the present invention with a trailer attached.

FIG. 2 is an elevated perspective view of the trailer hitch attached to the bomb disposal robot with the trailer removed.

FIG. 3 is an elevated perspective view of the trailer hitch of the present invention.

FIG. 4 is a side view of the trailer hitch of FIG. 3.

FIG. 5 is an elevated perspective view of another embodiment of the trailer hitch of the present invention.

FIG. 6 is a side view of the trailer hitch of FIG. 5.

FIG. 7 is an elevated perspective view of another embodiment of the trailer hitch of the present invention.

FIG. 8 is a side view of the trailer hitch of FIG. 7.

### DETAILED DESCRIPTION

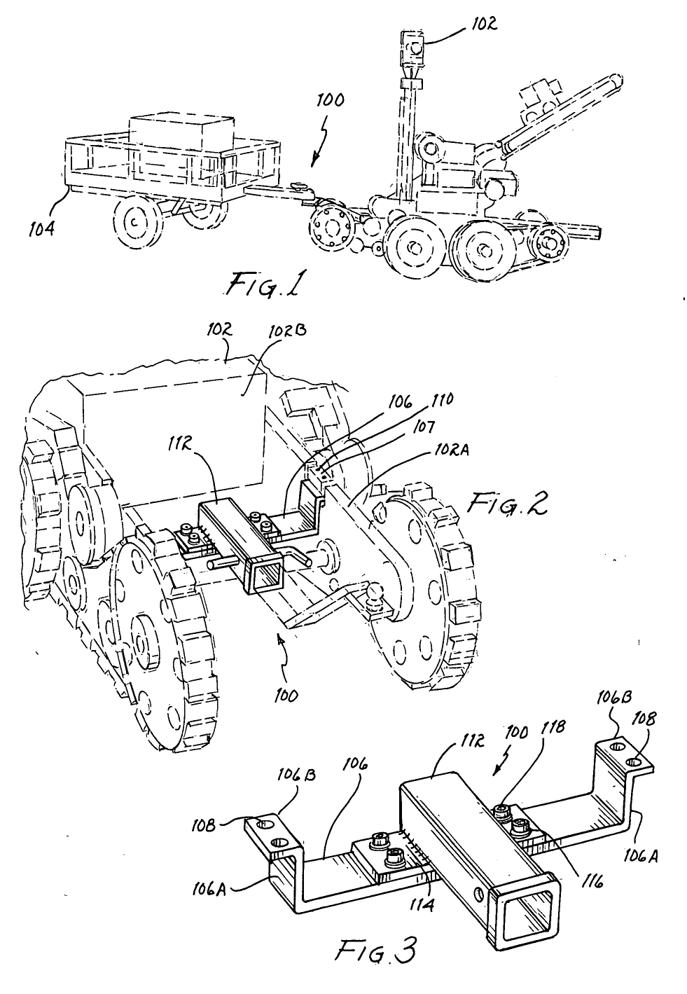

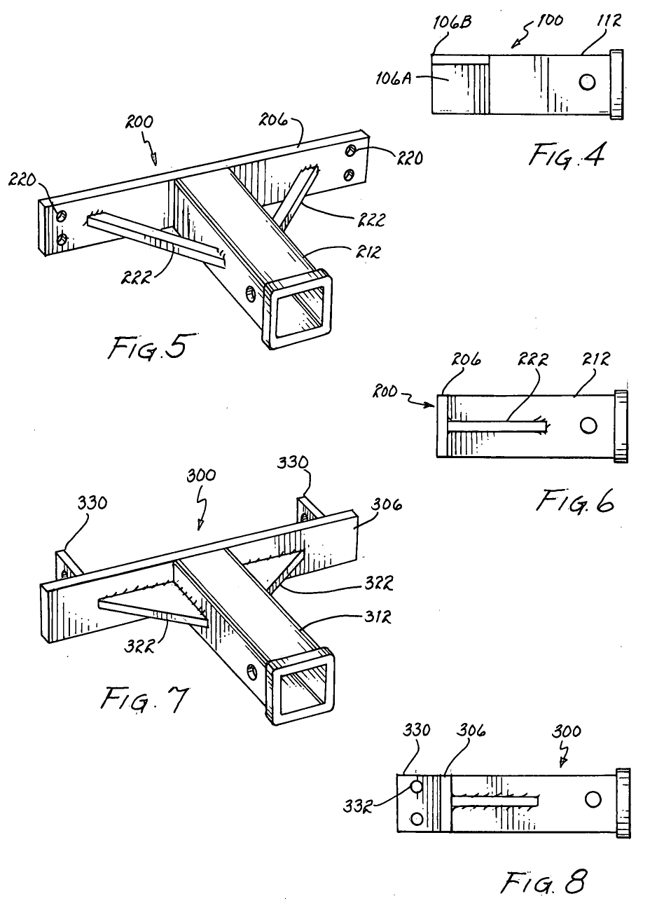

Referring to FIGS. 1-4, one embodiment of a trailer hitch assembly 100 for a bomb disposal robot 102 is shown. The trailer hitch assembly 100 will allow the bomb disposal robot to pull a trailer 104 or other device. The trailer 104 would allow the bomb disposal robot 102 to carry additional bomb disposal equipment. By carrying additional equipment, the bomb disposal robot 102 would be able to carry out more functions, thereby increasing the functionality of the bomb disposal robot 102.

The trailer hitch assembly 100 is specifically designed to be attached to a bomb disposal robot 102. The trailer hitch assembly 100 has a support beam 106. In the embodiment shown in FIGS. 1-4, the support beam 106 is rectangular in shape. However, this is shown as one example and should not be seen as to limit the scope of the present invention. The support beam 106 is laid flat. An “L” shape leg 106A extends above a first and second end of the support beam 106. The horizontal member 1069 of the leg 106A will be positioned above and extend away from the support beam 106. The horizontal member 106B will be approximately parallel to the support beam 106.

As shown in FIGS. 1 and 2, the horizontal member 106D of each leg 106A is coupled to the frame 102A of the bomb disposal robot 102. In accordance with one embodiment, one or more apertures 108 are formed through each horizontal member 106B of each leg 106A. The apertures 108 are used to secure the support beam 106 to the bomb disposal robot 102. The apertures 108 will align with apertures formed in a brace 107 coupled to the frame 102A of the bomb disposal robot 102. Alternatively, the apertures 10B will align with apertures formed in the frame 102A of the bomb disposal robot 102.

An attachment device 110 is placed through the apertures 108 and the apertures formed in the brace 107 or the frame 102A to secure the support beam 106 to the bomb disposal robot 102. The attachment device 110 may be a screw and nut assembly, rivets, or the like. The listing is given as an example and should not be seen as to limit the scope of the present invention. In an alternative embodiment, the horizontal member 106B of each leg 106A will rest on and is welded to the frame 102A of the bomb disposal robot 102.

A female trailer hitch connector 112 is coupled to a plate 114. In general, the female trailer hitch connector 112 is welded to the plate 114. However, the female trailer hitch connector 112 may be coupled to the plate 114 in other manners without departing from the spirit and scope of the present invention. In accordance with one embodiment of the present invention, the plate 114 is removably coupled to the support beam 106. This will allow different types of trailer hitch assemblies to be coupled to the support beam 106. In the embodiment depicted in FIGS. 1-4, the plate 114 will have one or more apertures 116 formed on a first end and a second end thereof. The apertures 116 are used to removably couple the female trailer hitch connector 112 to the support beam 106. The apertures 116 will align with apertures formed in the support beam 106. An attachment device 118 is placed through the apertures 116 and the apertures formed in the support beam 106 to secure the female trailer hitch connector 112 to the support beam 106 to the bomb disposal robot 102. The attachment device 118 may be a screw and nut assembly, rivets, or the like. The listing is given as an example and should not be seen as to limit the scope of the present invention. In an alternative embodiment, the female trailer hitch connector 112 will rest on and is welded to the support beam 106. As shown in FIG. 2, in operation, a ball and pin male trailer connector is inserted into the female trailer hitch connector 112.

Referring to FIGS. 5-6, another embodiment of the trailer hitch assembly 200 for a bomb disposal robot 102 (FIGS. 1 and 2) is shown. In this embodiment, the trailer hitch assembly 200 has a support beam 206. In the embodiment depicted in FIGS. 5-6, the support beam 206 is rectangular in shape. However, this is just one example and should not be seen as to limit the scope of the present invention. The support beam 206 is positioned in an upright position. The support beam 206 will have at least one opening 220 formed on a first end and a second end of the support beam 206. The openings 220 are used to secure the support beam 206 to the rear section 102B (FIGS. 1 and 2) of the frame 102A (FIGS. 1 and 2) of the bomb disposal robot 102.

A female trailer hitch connector 212 is coupled to the support beam 206. In general, the female trailer hitch connector 212 is welded to the support beam 206. However, the female trailer hitch connector 212 may be coupled to the support beam 206 in other manners without departing from the spirit and scope of the present invention.

A pair of support rods 222 is coupled to the female trailer hitch connector 212 and to the support beam 206. The support rods 222 are used to provide a better connection between the female trailer hitch connector 212 and the support beam 206.

Referring to FIGS. 7-8, another embodiment of the trailer hitch assembly 300 for a bomb disposal robot 102 (FIGS. 1 and 2) is shown. In this embodiment, the trailer hitch assembly 300 has a support beam 306. In the embodiment depicted in FIG. 7-8, the support beam 306 is rectangular in shape. However, this is just one example and should not be seen as to limit the scope of the present invention. The support beam 306 is positioned in an upright position.

A pair of mounting plates 330 is coupled to the support beam 306. The mounting plates 330 are coupled to a rear surface of the support beam 306. The mounting plates 330 will have at least one opening 332 formed there through. The openings 332 are used to secure the support beam 306 to the frame 102A of the bomb disposal robot 102.

A female trailer hitch connector 312 is coupled to the support beam 306. In general, the female trailer hitch connector 312 is welded to the support beam 306. However, the female trailer hitch connector 312 may be coupled to the support beam 306 in other manners without departing from the spirit and scope of the present invention.

A pair of support plates 322 is coupled to the female trailer hitch connector 312 and to the support beam 306. The support rods 322 are used to provide a better connection between the female trailer hitch connector 312 and the support beam 306.

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process may be implemented by one of skill in the art in view of this disclosure.

What is claimed is:

1. A trailer hitch assembly for a bomb disposal robot comprising:
a support beam for removably attaching the trailer hitch assembly to the bomb disposal robot; and
a female trailer hitch connector coupled to the support beam.

2. A trailer hitch assembly for a bomb disposal robot in accordance with claim 1 wherein the support beam further comprising an “L” shaped member extending from a first end and a second end of the support beam, the horizontal leg of the “L” shaped member extending above and away from the support beam, the horizontal leg of the “L” shaped member approximately parallel to the support beam.

3. A trailer hitch assembly for a bomb disposal robot in accordance with claim 2 wherein the support beam further comprises at least one opening formed in each horizontal leg of the “L” shaped member for removably attaching the trailer hitch assembly to the frame of the bomb disposal robot.

4. A trailer hitch assembly for a bomb disposal robot in accordance with claim 1 further comprising a support plate removably coupled top the support beam, the female trailer hitch connector attached to the support plate.

5. A trailer hitch assembly for a bomb disposal robot in accordance with claim 4 wherein the support plate further comprises at least one opening formed on a first end and a second end of the support plate to removably couple the support plate to the support beam.

6. A trailer hitch assembly for a bomb disposal robot in accordance with claim 1 further comprising a pair of support rods coupled to the support beam and the female trailer hitch connector.

7. A trailer hitch assembly for a bomb disposal robot in accordance with claim 6 further comprising a pair of openings formed in the support beam to removably couple the support beam to a rear frame section of the bomb disposal robot.

8. A trailer hitch assembly for a bomb disposal robot in accordance with claim 1 further comprising:
a pair of mounting plates coupled to the support beam for coupling the trailer hitch assembly to a frame of the bomb disposal robot; and
at least one opening formed in each mounting plate to removably couple the trailer hitch assembly to the frame of the bomb disposal robot.

9. A trailer hitch assembly for a bomb disposal robot in accordance with claim 8 further comprising a pair of support plates coupled to the support beam and the female trailer hitch connector.

10. A trailer hitch assembly for a bomb disposal robot comprising:
a support beam for removably attaching the trailer hitch assembly to the bomb disposal robot, wherein the support beam has an “L” shaped member extending from a first end and a second end of the support beam, the horizontal leg of the “L” shaped member extending above and away from the support beam, the horizontal leg of the “L” shaped member approximately parallel to the support beam;
a support plate removably coupled top the support beam; and
a female trailer hitch connector mounted to the support plate.

11. A trailer hitch assembly for a bomb disposal robot in accordance with claim 10 further comprises at least one opening formed in each horizontal leg of the “L” shaped member for removably attaching the trailer hitch assembly to the frame of the bomb disposal robot.

12. A trailer hitch assembly for a bomb disposal robot in accordance with claim 10 wherein the support plate further comprises at least one opening formed on a first end and a second end of the support plate to removably couple the support plate to the support beam.

13. A trailer hitch assembly for a bomb disposal robot comprising:
a support beam for removably attaching the trailer hitch assembly to the bomb disposal robot;
a female trailer hitch connector permanently mounted to the support beam; and
a pair of support members permanently attached to the support beam and the female trailer hitch connector.

14. A trailer hitch assembly for a bomb disposal robot in accordance with claim 13 wherein the pair of support members are a pair of support rods.

15. A trailer hitch assembly for a bomb disposal robot in accordance with claim 14 further comprising a pair of openings formed in the support beam to removably couple the support beam to a rear frame section of the bomb disposal robot.

16. A trailer hitch assembly for a bomb disposal robot in accordance with claim 13 further comprising:
a pair of mounting plates coupled to the support beam for coupling the trailer hitch assembly to a frame of the bomb disposal robot; and
at least one opening formed in each mounting plate to removably couple the trailer hitch assembly to the frame of the bomb disposal robot.

17. A trailer hitch assembly for a bomb disposal robot in accordance with claim 16 wherein the pair of support members are a pair of support plates.
